(19) United States
(12) Patent Application Publication
(10) Pub. No.: US 2014/0133022 A1
(43) Pub. Date: May 15, 2014

(54) THREE-DIMENSIONAL DISPLAY DEVICE AND METHOD OF MANUFACTURING THE SAME

(71) Applicant: KOREA ELECTRONICS TECHNOLOGY INSTITUTE, Gyeonggi-do (KR)

(72) Inventors: Young Min KIM, Seoul (KR); Byoung Ha PARK, Seoul (KR); Yang Keun AHN, Seoul (KR); Kwang Mo JUNG, Gyeonggi-do (KR)

(73) Assignee: KOREA ELECTRONICS TECHNOLOGY INSTITUTE, Gyeonggi-do (KR)

(21) Appl. No.: 13/855,367

(22) Filed: Apr. 2, 2013

(30) Foreign Application Priority Data
Nov. 12, 2012 (KR) 10-2012-0127516

(51) Int. Cl. G02B 27/22

(52) U.S. Cl. CPC G02B 27/2214
USPC 359/463; 29/428

(57) ABSTRACT

Provided are a 3D display device and a method of manufacturing the same. The 3D display device includes a curve-shaped display panel displaying an image, and a curve-shaped lenticular lens disposed in front of or behind the display panel. A left-eye image displayed by the display panel is presented to a user's left eye through the lenticular lens, and a right-eye image displayed by the display panel is presented to a user's left eye through the lenticular lens.

### CROSS-REFERENCE TO RELATED APPLICATIONS

This application claims priority under 35 U.S.C. §119 to Korean Patent Application No. 10-2012-0127516, filed on Nov. 12, 2012, the disclosure of which is incorporated herein by reference in its entirety.

### TECHNICAL FIELD

The present invention relates to a three-dimensional (3D) display device, and more particularly, to a 3D display device for providing a glasses-free 3D display image and a method of manufacturing the same.

### BACKGROUND

Recently, a 3D display device is applied to televisions, smartphones, home theater systems, etc.

Glasses-free 3D display devices of the related art are manufactured as flat panel display devices, and thus, optical elements are also manufactured in a flat type.

However, since the related art glasses-free 3D display devices use a flat panel and a flat type optical element, a viewing angle is restricted, and it is difficult to provide a natural 3D image.

### SUMMARY

Accordingly, the present invention provides a 3D display device for providing a 3D image and a method of manufacturing the same.

The object of the present invention is not limited to the aforesaid, but other objects not described herein will be clearly understood by those skilled in the art from descriptions below.

In one general aspect, a 3D display device includes: a curve-shaped display panel displaying an image; and a curve-shaped lenticular lens disposed in front of or behind the display panel, wherein a left-eye image displayed by the display panel is presented to a user's left eye through the lenticular lens, and a right-eye image displayed by the display panel is presented to a user's left eye through the lenticular lens.

In another general aspect, a method of manufacturing a 3D display device by a manufacturing apparatus includes: preparing a curve-shaped display panel; and disposing a curve-shaped lenticular lens in front of or behind a curve-shaped display panel, the curve-shaped lenticular lens corresponding to the curve shape of the display panel, wherein the disposing includes disposing the lenticular lens to be separated from the display panel by a predetermined gap, within a sector with the display panel as an arc, when the lenticular lens is disposed in front of the display panel.

Other features and aspects will be apparent from the following detailed description, the drawings, and the claims.

### BRIEF DESCRIPTION OF THE DRAWINGS

FIG. 1A is a block diagram illustrating a 3D display device according to an embodiment of the present invention.

FIG. 1B is a structural diagram illustrating a top of the 3D display device according to an embodiment of the present invention.

FIG. 2 is a conceptual diagram illustrating a lenticular lens according to an embodiment of the present invention.

FIG. 3 is a flowchart illustrating a method of manufacturing the 3D display device according to an embodiment of the present invention.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, embodiments of the present invention will be described in detail with reference to the accompanying drawings.

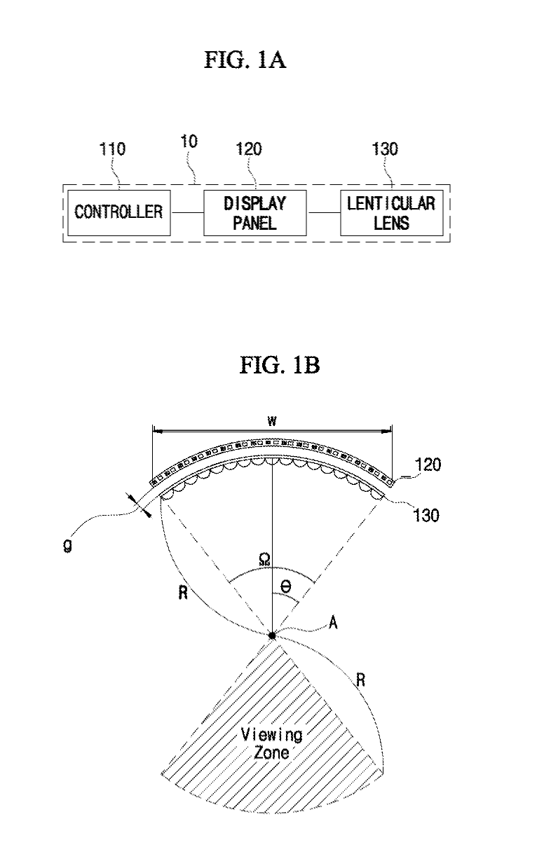

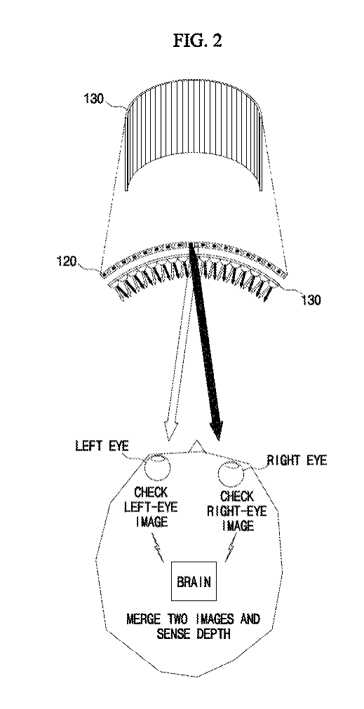

FIG. 1A is a block diagram illustrating a 3D display device according to an embodiment of the present invention. FIG. 1B is a structural diagram illustrating a top of the 3D display device according to an embodiment of the present invention. FIG. 2 is a conceptual diagram illustrating a lenticular lens according to an embodiment of the present invention.

Referring to FIG. 1, a 3D display device 10 according to an embodiment of the present invention includes a controller 110, a display panel 120, and lenticular lens 130.

The controller 110 is electrically connected to the display panel 120, generates a left-eye image to be presented to a user's left eye and a right-eye image to be presented to the user's right eye. And the controller 110 transfers the left-eye image and right-eye image to the display panel 120. Here, the controller 110 may be included in the display panel 120, and mounted on a substrate disposed at a front surface or rear surface of the display panel 120.

The display panel 120 receives the left-eye image and the right-eye image from the controller 110 to display the left-eye image and the right-eye image. At this point, the display panel 120 alternately displays the left-eye image and the right-eye image in units of one vertical line. The display panel 120 may be configured with a liquid crystal display (LCD), an organic light emitting diode (OLED), or a plasma display panel (PDP).

The display panel 120, as illustrated in FIG. 1B, is configured in a curved shape having a first radius. Here, the first radius may be calculated as expressed in the following Equation (1). In FIG. 1B, w denotes a length of a horizontal line of the display panel 120.

first radius=R+g (b 1)

where R denotes a radius of the lenticular lens 130, and g denotes a gap between the lenticular lens 130 and the display panel 120.

The lentiuclar lens 130, as illustrated in FIG. 1B, is disposed in front of or behind the display panel 120, and configured in a curved shape having a second radius “R”. FIG. 1B, as an example, illustrates a case in which the lenticular lens 130 is disposed in front of the display panel 120, but is not limited thereto.

A first surface of the lenticular lens 130 is formed in a shape where a plurality of semicylinder-shaped lenses is arranged in a curved shape, and a second surface of the lenticular lens 130 is formed in a smooth curved shape. FIG. 1B, as an example, illustrates a case in which a front surface of the lenticular lens 130 is the first surface and a rear surface of the lenticular lens 130 is the rear surface, but is not limited thereto. As another example, depending on a disposed position and characteristic of the lenticular lens 130, the rear surface of the lenticular lens 130 may be the first surface, and the front surface of the lenticular lens 130 may be the second surface.

The lenticular lens 130, as illustrated in FIG. 2, changes a phase of an image passing through the lenticular lens 130 according to an angle to provide a 3D image to a user in a viewing zone.

Specifically, the lentiuclar lens 130 causes a left-eye image (passing through a left portion in the semicylinder-shaped lenses) of the display panel 120 to be visible the user's left eye (see a black arrow of FIG. 2), and causes a right-eye image (passing through a right portion in the semicylinder-shaped lenses) of the display panel 120 to be visible the user's right eye (see a white arrow of FIG. 2). Thus, the user in the viewing zone can view the left-eye image and the right-eye image, which are alternately displayed on the display panel 120, as a 3D stereoscopic image.

The lenticular lens 130 may be formed of at least one of a silicon compound, a glass material, and a plastic material. For example, the lenticular lens 130 may be formed of polydimethylsiloxane (PDMS) that is a polymer containing silicon with good flexibility.

The lenticular lens 130 may be disposed to be separated from the display panel 120 by a gap “g” expressed as the following Equation (2), in a sector with the display panel 120 as an arc.

$$g = \frac{Rf}{R - f} \qquad ( 2 )$$

where R denotes a radius of the lenticular lens 120, and f denotes a focal distance of the lenticular lens 120.

To this end, when the lenticular lens 130 is disposed in front of the display panel 120, a length of the arc of the display panel 120 may be a curve length in which a second sector with the lenticular lens 130 as an arc is within a first sector with the display panel 120 as an arc. Here, the first and second sectors may have the same center located in the same position, and also have the same central angle.

On the other hand, when the lenticular lens 130 is disposed behind the display panel 120, a length of the arc of the lenticular lens 130 may be a curve length in which a second sector with the display panel 120 as an arc is within a first sector with the lenticular lens 130 as an arc. Here, the first and second sectors may have the same center located in the same position, and also have the same central angle.

The 3D display device 10 having the above-described configuration according to an embodiment of the present invention may provide a viewing angle “Θ” expressed as the following Equation (3).

$$Ω = 2 θ = 2 {n}_{max} arctan ( \frac{φ}{2 R} ) \qquad ( 3 )$$

where nₘₐₓ denotes the maximum number of semicylinder-shaped lenses included in the lenticular lens 120, and φ denotes a length of the arc of the lenticular lens 120 corresponding to a region in which each of the semicylinder-shaped lenses is disposed.

Moreover, the 3D display device 10 according to an embodiment of the present invention may provide a viewing zone equal to the same sector as a sector drawn by a point A (i.e., the center of the first and second sectors), the lenticular lens 130, and the radius of the lenticular lens 130 in front of the 3D display device 10 with respect to the point A. Accordingly, the 3D display device 10 can provide an enhanced viewing angle and viewing zone compared to the related art 3D display devices.

In the above-described embodiment, the 3D display device 10 that realizes a 3D image with the display panel 120 and the lenticular lens 130 has been described above as an example. But the 3D display device 10 may further include a plurality of parallax barriers (not shown) that are disposed between the display panel 120 and the lenticular lens 130 at periods equal to periods at which the left-eye image and right-eye image of the display panel 120 are displayed. Each of the parallax barriers (not shown) aids the left-eye of the display panel 120 to be presented to a user's left eye and aids the right-eye of the display panel 120 to be presented to the user's right eye together with the lenticular lens 130.

As described above, according to the present invention, by using the curve-shaped display panel and the curve-shaped optical element, crosstalk can be prevented, and a viewing angle of a screen displaying a 3D image can be enhanced, thus providing a natural 3D image.

Moreover, according to the present invention, a flexible lenticular lens corresponding to the curve-shaped display panel can be manufactured.

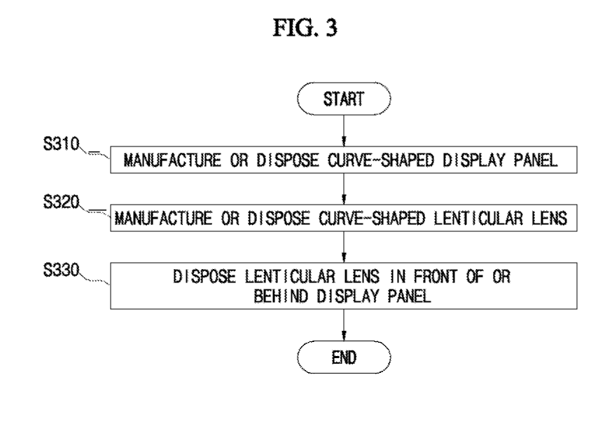

Hereinafter, a method of manufacturing the 3D display device according to an embodiment of the present invention will be described with reference to FIG. 3. FIG. 3 is a flowchart illustrating the method of manufacturing the 3D display device according to an embodiment of the present invention. The operation of FIG. 3 may be automatically performed by a 3D display manufacturing apparatus, or performed manually.

Referring to FIG. 3, the 3D display manufacturing apparatus manufactures or disposes the curve-shaped display panel 120 having the first radius in operation S310. Specifically, in operation S310, the 3D display manufacturing apparatus may manufacture the curve-shaped display panel 120, or, when using a manufactured curved-shaped display panel 120, the 3D display manufacturing apparatus may dispose the display panel 120 at a predetermined position in the 3D display device 10.

The 3D display manufacturing apparatus manufactures or disposes a curved-shape lenticular lens 130 having a second radius less or greater than the display panel 120 in operation S320.

In this case, the lenticular lens 130 may be formed of at least one of a silicon compound, a glass material, and a plastic material. Also, the lenticular lens 130 and the display panel 120 may be manufactured in a fan-shaped arc having the same central angle. For example, when the lenticular lens 130 is disposed in front of the display panel 120, the lenticular lens 130 is manufactured to have a radius less than that of the display panel 120. On the other hand, when the lenticular lens 130 is disposed behind the display panel 120, the display panel 120 is manufactured to have a radius greater than that of the lenticular lens 130.

The lenticular lens 130 is disposed at a position separated from the front of the display panel 120 by a predetermined gap “g” such that a sector with the curve-shaped lenticular lens 130 as an arc is within a sector with the display panel 120 as an arc. Here, the display panel 120 and the lenticular lens 130 may be disposed such that a center of a sector corresponding to the display panel 120 overlaps a center of a sector corresponding to the lenticular lens 130. Also, a gap “g” between the display panel 120 and the lenticular lens 130 is expressed as Equation (2).

In this case, when the lenticular lens 130 is disposed behind the display panel 120, the display panel 120 may be disposed to be separated from the display panel 120 by a predetermined gap, within the sector with the lenticular lens 130 as an arc.

Subsequently, when a left-eye image and a right-eye image are alternately displayed along a vertical line of the display panel 120, the left-eye image and the right-eye image are presented to a user's left and right eyes through the lenticular lens 130, thereby providing a 3D image to the user in a viewing zone.

As described above, according to the present invention, a viewing angle of a screen displaying a 3D image can be enhanced compared to the related art glasses-free display devices, and crosstalk can be prevented, thus providing a natural 3D image.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A three-dimensional (3D) display device, comprising:
a curve-shaped display panel displaying an image; and
a curve-shaped lenticular lens disposed in front of or behind the display panel,
wherein a left-eye image displayed by the display panel is presented to a user's left eye through the lenticular lens, and a right-eye image displayed by the display panel is presented to a user's left eye through the lenticular lens.

2. The 3D display device of claim 1, wherein a gap “g” between the display panel and the lenticular lens is calculated as expressed in the following Equation;
$$g = \frac{Rf}{R - f}$$
where R denotes a radius of the lenticular lens, and f denotes a focal distance of the lenticular lens.

3. The 3D display device of claim 1, further comprising at least one parallax barrier disposed between the display panel and the lenticular lens, and aiding the left-eye image to be presented to the left eye and the right-eye image to be presented to the right eye.

4. The 3D display device of claim 1, wherein the lenticular lens is formed of at least one of a silicon compound, a glass material, a plastic material, and polydimethylsiloxane (PDMS).

5. The 3D display device of claim 1, wherein a viewing angle “Θ” of the display panel is calculated as expressed in the following Equation;
$$θ = {n}_{max} arctan ( \frac{φ}{2 R} )$$
where nₘₐₓ denotes maximum number of semicylinder-shaped lenses comprised in the lenticular lens, φ denotes a length of an arc of the lenticular lens corresponding to a region in which each of the semicylinder-shaped lenses is disposed, and R denotes a radius of the lenticular lens.

6. A method of manufacturing a three-dimensional (3D) display device by a manufacturing apparatus, the method comprising:
preparing a curve-shaped display panel; and
disposing a curve-shaped lenticular lens in front of or behind the curve-shaped display panel, the curve-shaped lenticular lens corresponding to the curve shape of the display panel,
wherein the disposing comprises disposing the lenticular lens to be separated from the display panel by a predetermined gap, within a sector with the display panel as an arc, when the lenticular lens is disposed in front of the display panel.

7. The method of claim 6, wherein, in the disposing the curve-shaped lenticular lens, the gap is calculated as expressed in the following Equation;
$$g = \frac{Rf}{R - f}$$
where R denotes a radius of the lenticular lens, and f denotes a focal distance of the lenticular lens.

8. The method of claim 6, wherein the disposing the curve-shaped lenticular lens comprises disposing the display panel to be separated from the lenticular lens by the gap, within a sector with the lenticular lens as an arc, when the lenticular lens is disposed behind the display panel.
